(19) United States
(12) Patent Application Publication
(10) Pub. No.: US 2023/0345955 A1
(43) Pub. Date: Nov. 2, 2023

(54) CRACKER

(71) Applicant: MANINI CLAUDIO & C. SNC, CASTELVERDE (CR) (IT)

(72) Inventor: Claudio MANINI, CREMONA (IT)

(21) Appl. No.: 18/014,914

(22) PCT Filed: Jul. 7, 2021
(86) PCT No.: PCT/IT2021/050211

§ 371 Date: Jan. 6, 2023

(30) Foreign Application Priority Data
Jul. 8, 2020 (IT) 202020000004027

(51) Int. Cl. A21D 13/48

(52) U.S. Cl. CPC A21D 13/48

(57) ABSTRACT

Disclosed is a cracker including: a first section, adapted to be garnished or to come into contact with accompanying foods; and a second section, adapted to act as holding means for the fingers of the consumer, remaining extraneous, in use, to contact with the accompanying foods. The first and the second section coact with each other to define geometric shapes adapted to evoke objects associable through use or affinity with the accompanying foods or in any case to bring to mind and visually suggest the nature of the accompanying foods arranged on the first section or that must be picked up therewith.

### CROSS-REFERENCE TO RELATED APPLICATIONS

This application is the U.S. national phase of International Application No. PCT/IT2021/050211 filed Jul. 7, 2021, which designated the U.S. and claims priority to IT 202020000004027 filed Jul. 8, 2020, the entire contents of each of which are hereby incorporated by reference.

### BACKGROUND OF THE INVENTION

### Field of the Invention

The present utility model is directed at the food industry and restaurant sector. More in detail, the invention relates to a single-serving cracker, or salted biscuit, adapted to be garnished on the surface with foods of various kinds and served together with alcoholic or non-alcoholic aperitifs, or similar beverages.

### Description of the Related Art

The use of alcoholic aperitifs or similar beverages is closely linked to the tasting of small portions of foods of various kinds (cured meats, cheeses, vegetables, savoury and sweet creams, jams, etc.) which, served with breadsticks or on bases of slices of focaccia or pizza, sliced bread (toasted or untoasted), are carried to the mouth directly using the hands and then eaten in subsequent bites.

This puts consumers at risk of possibly soiling their clothes due to the accompanying foods falling from the bases on which they are served, facilitated by the inevitably irregular shapes thereof, while carrying them to the mouth or biting them.

A further cause of indirect soiling of consumers' clothes or personal objects (eyewear, phones, bags, etc.) is represented by contact between the hands and the tastings, if accidentally soiled by the accompanying foods arranged on the supporting bases, while carrying them to the mouth.

The object of the present utility model is therefore to overcome these problems.

### SUMMARY OF THE INVENTION

The object of the present utility model is achieved with a cracker that includes:
a first section, adapted to be garnished or to come into contact with accompanying foods;
a second section, adapted to act as holding means for the fingers of the consumer, remaining extraneous, in use, to contact with the accompanying foods,
where the first and the second section coact with each other to define geometric shapes adapted to evoke objects associable through use or affinity with the accompanying foods or in any case to bring to mind and visually suggest the nature of the accompanying foods arranged on the first section or that must be picked up therewith.

Further features of the cracker of the present utility model are described and claimed.

The cracker or salted biscuit of the present utility model produces the following advantages:
by means of a first flat section, it facilitates arranging accompanying foods thereon, preventing the possible dropping thereof while being carried to the mouth of the consumer;
by means of a second section, protruding from the first, it facilitates holding by the consumer with the fingers, preventing the possible dirtying thereof by the accompanying foods arranged on said first section;
by means of said first and second section, it defines geometric shapes adapted to evoke and visually suggest the accompanying foods arranged thereon.

### BRIEF DESCRIPTION OF THE DRAWINGS

Further features and advantages of the present utility model will be more apparent from the more detailed description set forth below, with the aid of the drawings, which show preferred embodiments thereof, illustrated by way of non-limiting example, wherein:

FIGS. 1A, 1B, 1C show, respectively in a three-dimensional view from above and in a flat view from above and from the side, a cracker according to the present utility model;

FIGS. 2A, 2B, 2C and 3A, 3B, 3C show, with respective three-dimensional views from above and flat views from above and from the side, two possible variants of shape of said cracker.

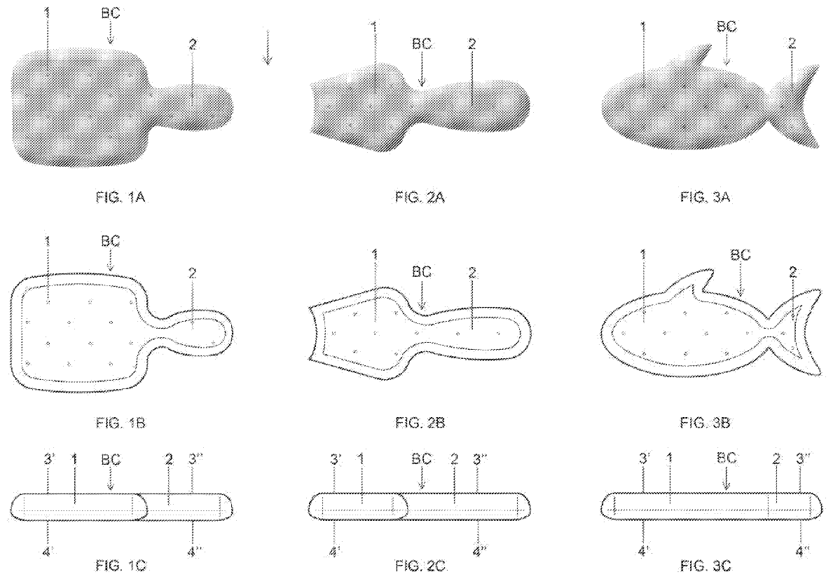

### DESCRIPTION OF THE PREFERRED EMBODIMENTS

With reference to the details of the figures, a cracker or salted biscuit BC according to the present utility model comprises substantially:
a first section 1, adapted to be garnished or in any case come into contact with accompanying foods, which can be eaten with said cracker or salted biscuit BC;
a second section 2, adapted to act as holding means for the fingers of the consumer, remaining extraneous, in use, to contact with the accompanying foods.

The first 1 and the second 2 section of the cracker or salted biscuit BC coact with each other to define geometric shapes adapted to evoke objects associable through use or affinity with the accompanying foods, or in any case to bring to mind and visually suggest the nature of the accompanying foods arranged on the first section 1 or that must be picked up therewith.

The first section 1 of the cracker or salted biscuit BC has, in the three variants illustrated by the figures, an indicatively rectangular, trapezoidal or ovoid shape. However, said first section can naturally have other shapes to achieve the same purpose.

The second section 2 of the cracker BC or salted biscuit has a selectively linear, tapered or curved shape, protruding from the first section 1, to evoke, with the first section 1, for example:
a cutting board, adapted to be paired with accompanying foods comprising cured meats or cheeses;
a spatula (or spoon), adapted to be paired with accompanying foods comprising savoury and sweet creams, jams, sauces or spreading cheeses;
a fish, adapted to be paired with accompanying foods based on fish, crustaceans, shellfish, savoury creamy spreads, etc.

The first section 1 and the second section 2 of the cracker or salted biscuit BC have upper 3′, 3″ and lower 4′, 4″ surfaces substantially flat and parallel to each other, with holes to facilitate leavening and baking according to the prior art.

The principle of use of a cracker or salted biscuit BC according to the present utility model can be summed up as described below.

The cracker or salted biscuit BC is produced with sections 1, 2 structured as a function of the nature of the accompanying foods pairable therewith by the user.

The cracker or salted biscuit BC is prepared by the bartender or by the user, garnishing the upper surface 3′ of the section 1 with an accompanying food appropriate for its shape and offered to the consumer on serving plates or trays, placed on the lower surfaces 4′, 4″ of the sections 1, 2. Alternatively, the cracker or salted biscuit BC is provided without garnishing and, in particular when it has a spatula shaped structure, used to pick up creamy foods.

The flat structure of the upper surface 3′ of the section 1 facilitates even distribution of the accompanying food thereon and consequently prevents it from falling when the cracker or salted biscuit BC is carried to the mouth of the consumer.

The flat structure of the lower surfaces 4′, 4″ of the sections 1, 2 instead promotes a stable arrangement of the cracker or salted biscuit BC, appropriately garnished, on serving plates or trays and consequently optimal presentation thereof to the consumer.

Using only the section 2, the consumer will pick up a cracker or salted biscuit BC, appropriately garnished, with the fingers from the serving plate or tray and carry it to the mouth to taste it in a single bite.

The section 2 of the cracker or salted biscuit BC, protruding from the section 1, will prevent the fingers of the consumer from coming into contact with the accompanying foods and consequently prevent soiling of their clothes due to contact with the fingers.

1. A cracker comprising:
a first section, adapted to be garnished or to come into contact with accompanying foods;
a second section, adapted to act as holding means for the fingers of the consumer, remaining extraneous, in use, to contact with the accompanying foods,
where the first and the second section coact with each other to define geometric shapes adapted to evoke objects associable through use or affinity with the accompanying foods or in any case to bring to mind and visually suggest the nature of the accompanying foods arranged on the first section or that must be picked up therewith.

2. The cracker according to claim 1, wherein the second section protrudes from the first section.

3. The cracker according to claim 1, wherein the first and the second section have upper and lower surfaces substantially flat and parallel to each other.

4. The cracker according to claim 1, wherein the first section has a substantially rectangular shape.

5. The cracker according to claim 1, wherein the first section has a substantially trapezoidal shape.

6. The cracker according to claim 1, wherein the first section has a substantially ovoid shape.

7. The cracker according to claim 1, wherein the second section has a shape chosen between linear, tapered or curved.
